(19) United States
(12) Patent Application Publication
(10) Pub. No.: US 2018/0195622 A1
(43) Pub. Date: Jul. 12, 2018

(54) SLIDE VALVE

(71) Applicant: SHIMADZU CORPORATION, Kyoto (JP)

(72) Inventor: Masahito KOGAME, Kyoto (JP)

(21) Appl. No.: 15/863,936

(22) Filed: Jan. 7, 2018

(30) Foreign Application Priority Data
Jan. 12, 2017 (JP) 2017-003441

(51) Int. Cl. F16K 3/02; F16K 31/06

(52) U.S. Cl. CPC F16K 3/0254; F16K 31/0679; F16K 31/0668; F16K 3/0227

(57) ABSTRACT

A slide valve comprises: a housing provided with a pair of openings facing each other; a valve body; a biasing portion configured to bias the sealing body to the valve closed state; a cylinder into which compressed air for biasing the sealing body to a valve open state is introduced; a switching flow path connected to the cylinder and configured to switch a connection destination of the cylinder between a compressed air supply source and an exhaust port; a first solenoid configured to switch the switching flow path according to a valve body release command such that the cylinder and the compressed air supply source are connected together; and a second solenoid configured to switch the switching flow path according to a valve body fixing command such that the cylinder and the exhaust port are connected together.

### TECHNICAL FIELD

The present invention relates to a slide valve.

### BACKGROUND ART

A slide valve has been known, which is configured to slide and detachably insert a slide plate into a flow path, thereby adjusting a flow rate (Patent Literature 1: U.S. Pat. No. 5,577,707). For bringing the slide valve into a fully-closed state, an annular sealing body provided with a seal ring comes into contact with an edge portion of the slide plate inserted into the flow path, and in this manner, the flow path is blocked. The force of causing the sealing body to contact the slide plate is applied to the sealing body by a spring, and the force of separating the sealing body from the slide plate is applied to the sealing body by compressed air.

The compressed air supplied to the slide valve is often controlled by a solenoid valve including a single solenoid and the spring. When voltage is applied to the solenoid, the compressed air is supplied to the slide valve. When voltage application is terminated, a compressed air supply is stopped by the spring.

In the technique described in Patent Literature 1, the compressed air supply to the slide valve is stopped when a power supply to the solenoid valve is stopped. This cannot prevent movement of the sealing body.

### SUMMARY OF THE INVENTION

A slide valve comprises: a housing provided with a pair of openings facing each other; a valve body detachably inserted between the pair of openings; an annular sealing body configured to slidably move, in the housing, in a direction in which the pair of openings face each other, thereby contacting the valve body inserted between the pair of openings to bring a valve closed state; a biasing portion configured to bias the sealing body to the valve closed state; a cylinder into which compressed air for biasing the sealing body to a valve open state is introduced; a switching flow path connected to the cylinder and configured to switch a connection destination of the cylinder between a compressed air supply source and an exhaust port; a first solenoid configured to switch the switching flow path according to a valve body release command such that the cylinder and the compressed air supply source are connected together; and a second solenoid configured to switch the switching flow path according to a valve body fixing command such that the cylinder and the exhaust port are connected together.

When voltage is applied to the first solenoid and no voltage is applied to the second solenoid, the switching flow path is switched such that the cylinder and the compressed air supply source are connected together. When voltage is applied to the second solenoid and no voltage is applied to the first solenoid, the switching flow path is switched such that the cylinder and the exhaust port are connected together. When no voltage is applied to the first solenoid and the second solenoid, a state of the switching flow path is not changed.

The slide valve further comprises: in a line for guiding the compressed air from the compressed air supply source to the switching flow path, a check valve configured to block a flow from the switching flow path to the compressed air supply source.

The valve body moves in a direction intersecting a direction in which the sealing body slidably moves. The sealing body includes a detachable sealing member.

According to the present invention, a compressed air supply to a slide valve is not stopped even when a power supply to a solenoid valve is stopped, and therefore, a sealing body can be held at a certain position.

### BRIEF DESCRIPTION OF THE DRAWINGS

FIG. 1 is a view of an outer appearance of a slide valve;

FIG. 2 is a schematic view of structures of a solenoid valve and a check valve;

FIG. 3 is a sectional view along an III-III line of FIG. 1 in a temporarily-blocked state of the slide valve;

FIG. 4A is a sectional view of a flange in an axial direction, FIG. 4B is a sectional view of a piston portion in the axial direction, and FIG. 4C is a sectional view of a seal ring in the axial direction;

FIG. 5 is a sectional view along the III-III line of FIG. 1 in a fully-blocked state of the slide valve; and

FIG. 6 is a view of an example of a situation where a sealing body contacts a slide plate in a state in which the slide plate is not fully closed.

### DETAILED DESCRIPTION OF THE EXEMPLARY EMBODIMENTS

### Embodiment

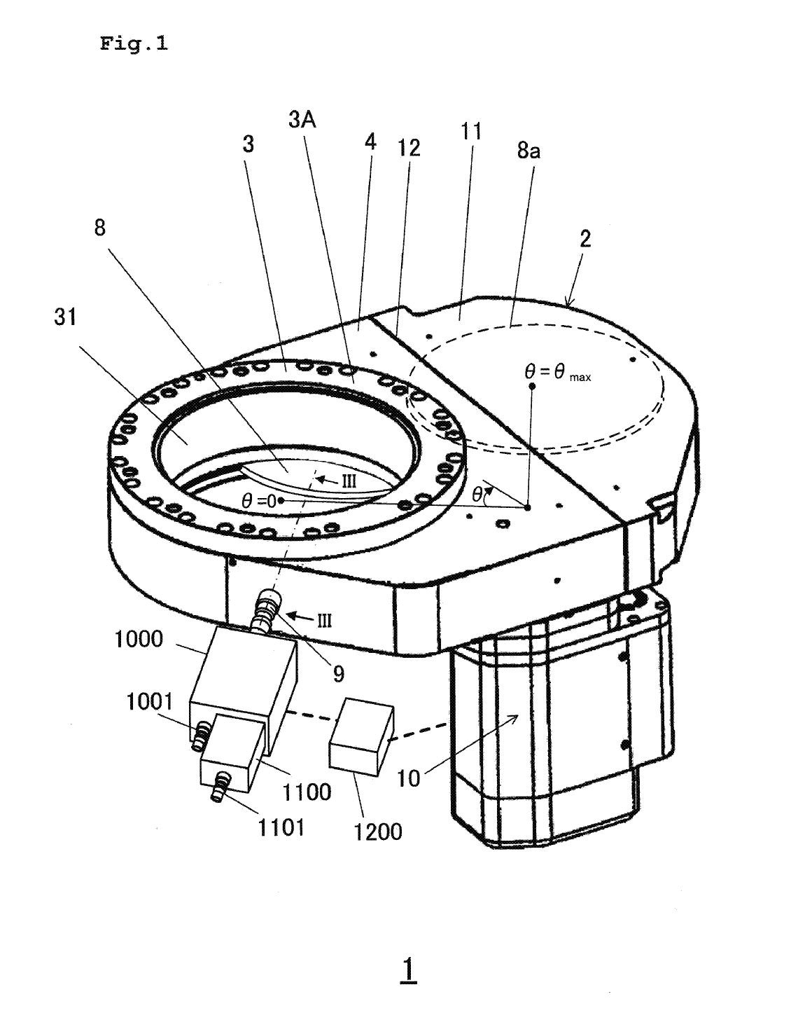

Hereinafter, an embodiment of a slide valve of the present invention will be described with reference to FIGS. 1 to 6. FIG. 1 is a perspective view of an outer appearance of a slide valve 1.

### Overview of Configuration

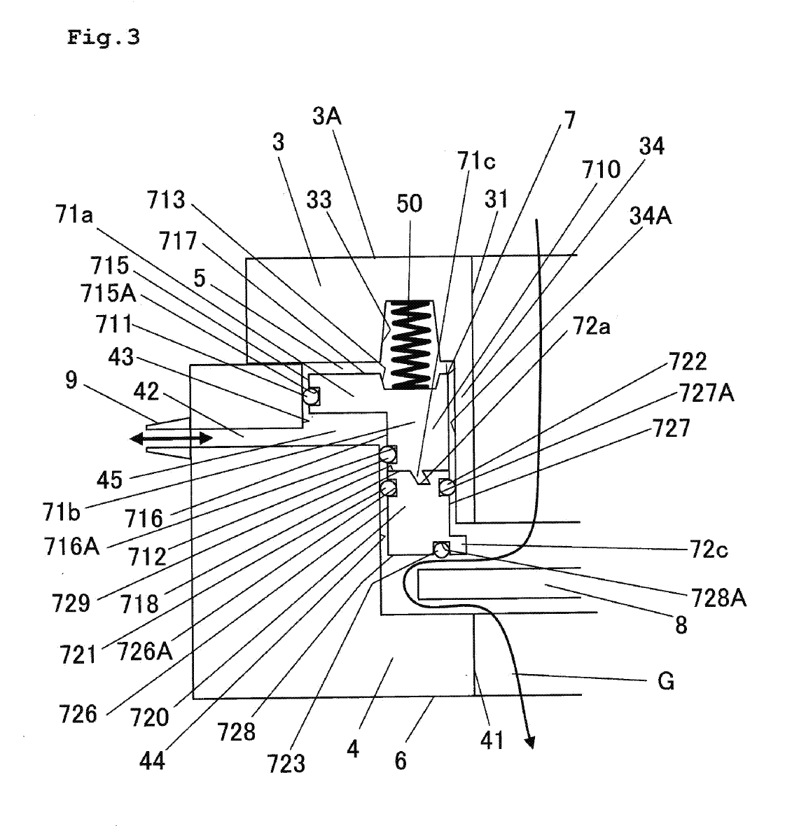

The slide valve 1 includes a housing 2, a drive section 10, a solenoid valve 1000, a check valve 1100, and a controller 1200. The housing 2 includes a flange 3, a housing base portion 4 provided with a fastening surface 6 (see FIG. 3) and a coupler 9, and a valve body, i.e., a slide plate 8, slidably driven in the housing base portion 4. For example, a vacuum chamber of a vacuum processing device is fixed to a fastening surface 3A of the flange 3, and a vacuum pump is fixed to the fastening surface 6. Although not shown in the figure, the drive section 10 is provided with a motor configured to swingably drive the slide plate 8 and a control section configured to drivably control the motor. The control section of the drive section 10 drives the slide plate 8 based on a command from the controller 1200, and outputs the position of the slide plate 8 to the controller 1200.

A sign “θ” illustrated in FIG. 1 represents the opening degree θ of the slide plate 8. An expression “θ=0” illustrated in the figure represents a predetermined opening degree θ for fully closing an opening 31 of the flange 3, and “θ=θmax” represents an opening degree θ for fully opening the opening 31 of the flange 3. A slide plate 8a indicated by a dashed line is the slide plate 8 in the fully-open state (θ=θmax). The slide plate 8 is swingably driven by the motor of the drive section 10 to adjust the opening degree θ, thereby adjusting the flow rate of gas flowing from the vacuum processing device to the vacuum pump.

Hereinafter, the slide plate 8 in the state of “θ=0” will be referred to as being in a “fully-closed” state. Although described in detail later, when a later-described sealing body comes into contact with the slide plate 8 in the fully-closed state of the slide plate 8, a flow before and after the slide valve 1 is fully blocked by the slide valve 1. Hereinafter, a state in which the sealing body contacts the slide plate 8 in the fully-closed state will be referred to as a “fully-blocked state,” and a state in which the sealing body does not contact the slide plate 8 in the fully-closed state will be referred to as a “temporarily-blocked state.”

The housing 2 has an extraction port 12 provided with an openable cover 11. This cover 11 is provided for replacing a component provided in the housing 2, such as later-described seal materials, without detaching the slide valve 1 from the vacuum processing device and the vacuum pump.

The controller 1200 outputs an operation command to the drive section 10 based on external input. The controller 1200 obtains the position of the slide plate 8 from the control section of the drive section 10. When determining that the slide plate 8 is in the fully-closed state, the controller 1200 outputs the operation command to the solenoid valve 1000 to cause the sealing body to contact the slide plate 8, thereby bringing the fully-blocked state.

A valve unit is attached to the coupler 9 of the housing base portion 4. The valve unit includes the solenoid valve 1000 and the check valve 1100. Compressed air flows into the coupler 9 from the valve unit. The compressed air is discharged from the coupler 9 to the valve unit. Action of the compressed air having flowed into the housing base portion 4 will be described later with reference to FIG. 3.

Although described in detail later, the compressed air flows into the check valve 1100 through a port 1101, and flows into the housing base portion 4 by way of the solenoid valve 1000 and the coupler 9. The air flowing out of the housing base portion 4 is emitted through an exhaust port 1001 of the solenoid valve 1000 by way of the coupler 9 and the solenoid valve 1000.

### Solenoid Valve

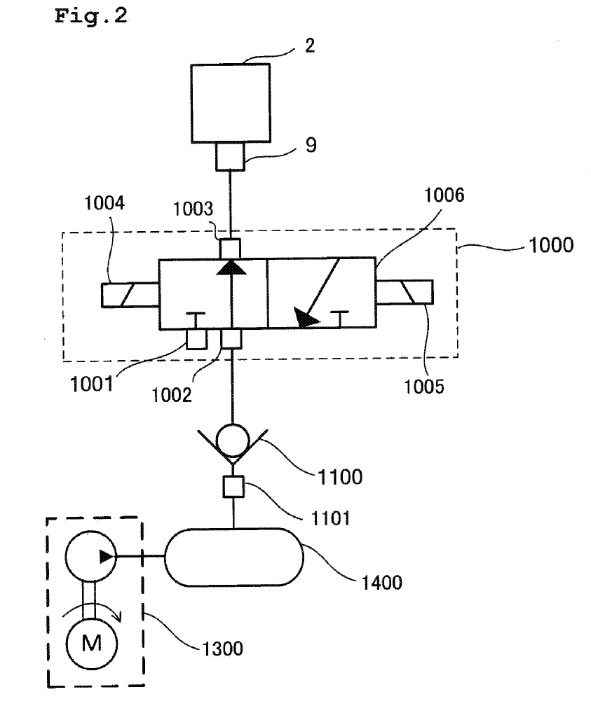

FIG. 2 is a schematic view of structures of the solenoid valve 1000 and the check valve 1100 and equipment connected to the check valve 1100. As illustrated in FIG. 2, the high-pressure air generated by a compressor 1300 is stored in a tank 1400, and the compressed air is supplied from the tank 1400 to the check valve 1100 by way of the port 1101.

The solenoid valve 1000 includes a first solenoid 1004, a second solenoid 1005, the exhaust port 1001, a tank-side port 1002, a valve-side port 1003, and a switching flow path 1006. The exhaust port 1001 is exposed to atmosphere. The tank-side port 1002 is connected to the check valve 1100. The first solenoid 1004 and the second solenoid 1005 are operated by the command from the controller 1200.

The check valve 1100 is configured to block a flow from the solenoid valve 1000 toward a compressed air supply source. That is, the check valve 1100 prevents the compressed air from flowing out of the housing base portion 4 even in a case where the pressure of the compressed air supply source reaches lower than the internal pressure of the housing base portion 4 due to stop of operation of the compressor 1300.

The switching flow path 1006 of the solenoid valve 1000 is switchable between an introduction state in which the tank-side port 1002 and the valve-side port 1003 are connected together and an exhaust state in which the exhaust port 1001 and the valve-side port 1003 are connected together. FIG. 2 illustrates the switching flow path 1006 in the introduction state.

The switching flow path 1006 of the solenoid valve 1000 is brought into the introduction state when voltage is applied from the controller 1200 to the first solenoid 1004 in a state in which no voltage is applied to the second solenoid 1005, and therefore, the tank-side port 1002 and the valve-side port 1003 are connected together. That is, voltage application from the controller 1200 to the first solenoid 1004 is equivalent to a release command for releasing the slide plate 8 fixed at a predetermined position by the sealing body 7.

The switching flow path 1006 of the solenoid valve 1000 is brought into the exhaust state when voltage is applied only to the second solenoid 1005 from the controller 1200 in a state in which no voltage is applied to the first solenoid 1004, and therefore, the exhaust port 1001 and the valve-side port 1003 are connected together. That is, voltage application from the controller 1200 to the second solenoid 1005 is equivalent to a fixing command for fixing the slide plate 8 by the sealing body 7.

In a state in which no voltage is applied to the first solenoid 1004 and the second solenoid 1005, the switching flow path 1006 of the solenoid valve 1000 maintains the current introduction state or exhaust state. That is, in the introduction state, when voltage is no longer applied to the first solenoid 1004 and the second solenoid 1005 due to blackout etc., the introduction state is maintained, and the state in which the tank-side port 1002 and the valve-side port 1003 are connected together is maintained. On the other hand, in the exhaust state, when voltage is no longer applied to the first solenoid 1004 and the second solenoid 1005 due to blackout etc., the exhaust state is maintained, and the state in which the exhaust port 1001 and the valve-side port 1003 are connected together is maintained.

### Structure of Slide Valve

FIG. 3 is a sectional view along an line of FIG. 1. Unlike FIG. 1, FIG. 3 illustrates the slide plate 8 in the fully-closed state (θ=0). FIG. 3 is similar to FIG. 1 in that the sealing body 7 does not contact the slide plate 8. That is, the slide valve 1 illustrated in FIG. 3 is in the temporarily-blocked state.

The flange 3 includes the fastening surface 3A, the opening 31, a recessed portion 33, and a cylindrical portion 34. The housing base portion 4 includes the coupler 9, a ventilation port 42, an opening 41, and the fastening surface 6. Note that although not shown in the figure, the flange 3 and the housing base portion 4 are bolted together.

The opening 31 and the opening 41 face each other. The slide plate 8 is detachably inserted between the opening 31 and the opening 41. Note that a side (an upper side as viewed in FIG. 3) close to the fastening surface 3A in a direction (an upper-to-lower direction as viewed in FIG. 3) in which the opening 31 and the opening 41 face each other will be hereinafter simply referred to as a “fastening surface 3A side,” and a side (a lower side as viewed in FIG. 3) close to the fastening surface 6 in the direction in which the opening 31 and the opening 41 face each other will be hereinafter simply referred to as a “fastening surface 6 side.”

The housing 2 includes a cylindrical housing portion 5 between the flange 3 and the housing base portion 4. The housing portion 5 includes a later-described cylindrical inner peripheral wall surface having an outer peripheral surface 34A of the cylindrical portion 34, and a later-described cylindrical outer peripheral wall surface having an inner peripheral surface 43. The sealing body 7 entirely formed in an annular shape is housed in the housing portion 5.

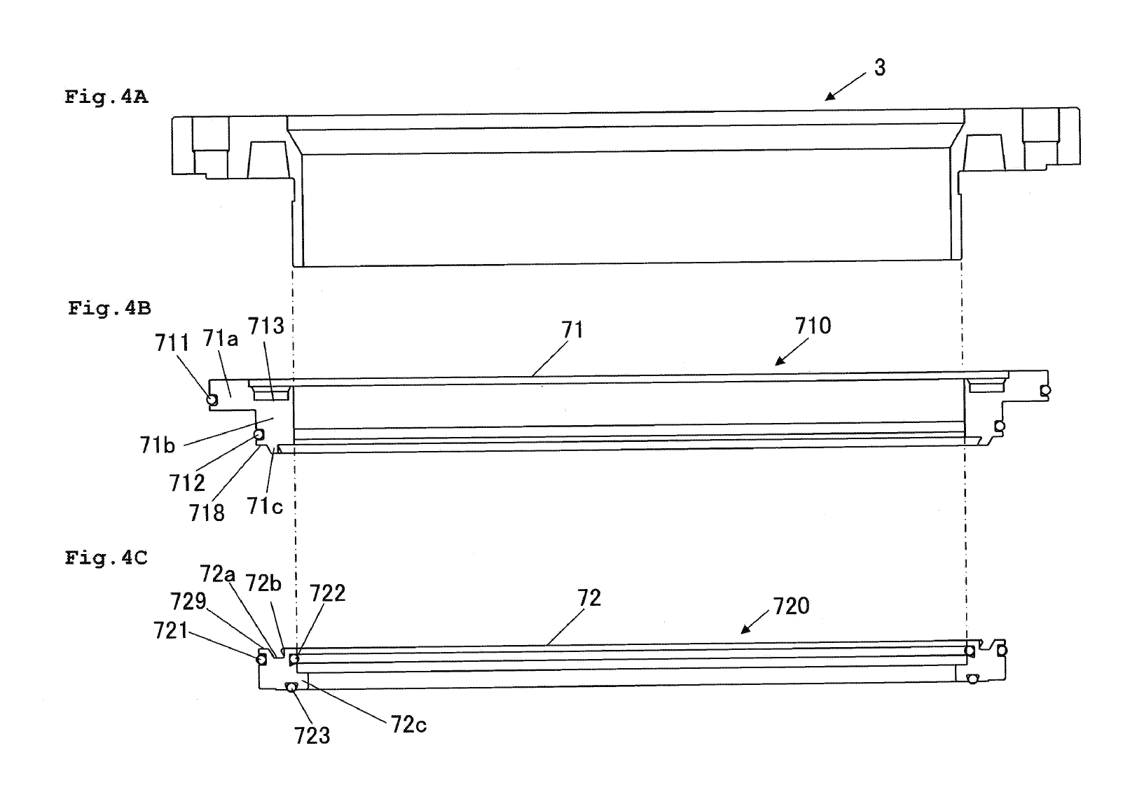

The sealing body 7 includes an annular piston portion 710 and an annular seal ring 720. Structures of the piston portion 710 and the seal ring 720 will be further described herein with reference to FIGS. 4A to 4C. FIG. 4A is a sectional view of the flange 3 in an axial direction. FIG. 4B is a sectional view of the piston portion 710 in the axial direction. FIG. 4C is a sectional view of the seal ring 720 in the axial direction. As illustrated in FIGS. 4A to 4C, the flange 3, the piston portion 710, and the seal ring 720 are produced as separate bodies.

As illustrated in FIG. 4B, the piston portion 710 includes a base portion 71, the seal material 711, and the seal material 712. The base portion 71 includes a pressure receiving portion 71a, a cylindrical portion 71b, a raised portion 71c, and a recessed portion 713. As illustrated in FIG. 4C, the seal ring 720 includes a base portion 72, the seal material 721, the seal material 722, and the seal material 723. The base portion 72 includes a groove 72a, an engagement portion 72b, and a circular ring portion 72c.

Returning to description of FIG. 3, the piston portion 710 has a large-diameter portion 715 and a small-diameter portion 716 as illustrated in FIG. 3. An outer peripheral surface of the large-diameter portion 715 is an outer peripheral surface of the pressure receiving portion 71a, and an outer peripheral surface of the small-diameter portion 716 is an outer peripheral surface of the cylindrical portion 71b. The piston portion 710 includes the seal material 711 in a recessed portion 715A provided at the large-diameter portion 715, as well as including the seal material 712 in a recessed portion 716A provided at the small-diameter portion 716. The piston portion 710 further includes the recessed portion 713 at an end surface 717 facing the recessed portion 33 of the flange 3, as well as including the raised portion 71c at a connection surface 718 with the seal ring 720.

The seal ring 720 includes the seal material 721 in a recessed portion 726A provided at an outer peripheral surface 726, the seal material 722 in a recessed portion 727A provided at an inner peripheral surface 727, the seal material 723 in a recessed portion 728A provided at an end surface 728 on the fastening surface 6 side, and the groove 72a at a connection surface 729 as an end surface on the fastening surface 3A side.

A compression spring 50 is provided between the recessed portion 33 and the recessed portion 713.

The piston portion 710 and the seal ring 720 are connected together by engagement between the raised portion 71c and the groove 72a. Thus, the piston portion 710 and the seal ring 720 integrally move as the sealing body 7.

The compressed air introduced from the coupler 9 passes through the ventilation port 42, and then, flows into a cylinder chamber 45 as a space divided by the seal materials 711, 712. Then, the compressed air acts on the pressure receiving portion 71a of the piston portion 710. The seal material 711 seals a clearance between the piston portion 710 and the inner peripheral surface 43 of the housing base portion 4. The seal material 712 seals a clearance between the piston portion 710 and an inner peripheral surface 44 of the housing base portion 4. Sealing by the seal materials 711, 712 prevents the compressed air from leaking from the cylinder chamber 45. The piston portion 710 receives force from the compressed air toward the fastening surface 3A side through the pressure receiving portion 71a. Moreover, the piston portion 710 receives force from the compression spring 50 toward the fastening surface 6 side through the recessed portion 713. In a case where the force received from the compressed air is greater than the force received from the compression spring 50, the sealing body 7 slidably moves toward the fastening surface 3A side. Conversely, in a case where the force received from the compression spring 50 is greater than the force received from the compressed air, the sealing body 7 slidably moves toward the fastening surface 6 side. That is, the sealing body 7 slidably moves, by the compression spring 50 and the compressed air, in the direction in which the opening 31 and the opening 41 face each other.

The seal materials provided at the piston portion 710 and the seal ring 720 cannot avoid wearing due to friction, and therefore, are detachable for component replacement. For replacing these seal materials, the compressed air is introduced into the cylinder chamber 45 to move the sealing body 7 toward the fastening surface 3A side, and an access is made through the extraction port 12 (see FIG. 1).

### Fully-Blocked State of Slide Valve

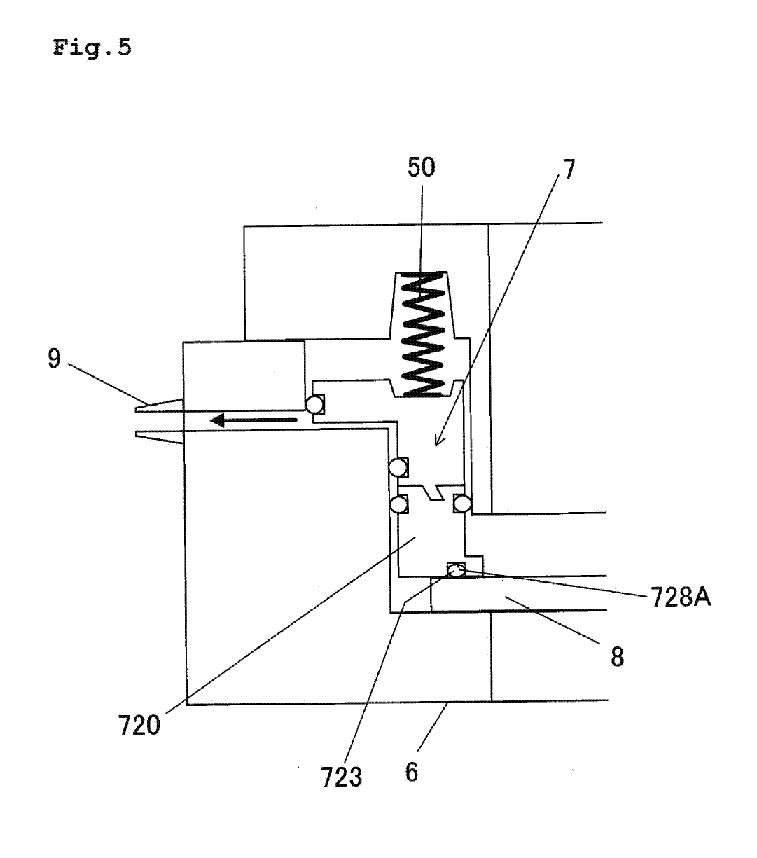

FIG. 5 is a sectional view along the line of FIG. 1 in the fully-blocked state of the slide valve 1, i.e., a view after the position of the sealing body 7 has been changed from FIG. 3 illustrating the temporarily-blocked state.

The controller 1200 applies voltage to the second solenoid 1005 of the solenoid valve 1000 when the slide plate 8 is in the fully-closed state (θ=0). As described above, when voltage is applied to the second solenoid 1005 in the state in which no voltage is applied to the first solenoid 1004, the exhaust port 1001 and the valve-side port 1003 of the solenoid valve 1000 are connected together, and the compressed air is discharged from the housing base portion 4 by way of the coupler 9. Thus, as illustrated in FIG. 5, the sealing body 7 receives the force of the compression spring 50 to slidably move toward the fastening surface 6 side. Then, the sealing body 7 comes into contact with the slide plate 8 through the seal material 723 of the seal ring 720. This can block gas (gas G illustrated in FIG. 3) passing through the slide valve 1, i.e., can bring the slide valve 1 into the fully-blocked state. In this state, the seal material 723 contacts the slide plate 8 across the maximum possible contact area. In other words, the seal material 723 uniformly contacts the slide plate 8 across a wide area, and is stably retained in the recessed portion 728A.

According to the above-described embodiment, the following features and advantageous effects are provided.

(1) The slide valve 1 includes the housing 2 provided with the pair of openings 31, 41 facing each other, the slide plate 8 detachably inserted between the openings 31, 41, and the annular sealing body 7 configured to slidably move, in the housing 2, in the direction in which the openings 31, 41 face each other, i.e., the upper-to-lower direction of FIG. 3, thereby contacting the slide plate 8 inserted between the openings 31, 41 to bring the valve closed state. The slide valve 1 further includes the compression spring 50 configured to bias the sealing body 7 to the valve closed state, the cylinder chamber 45 into which the compressed air for biasing the sealing body 7 to the valve open state is introduced, and the switching flow path 1006 connected to the cylinder chamber 45 and configured to switch a connection destination of the cylinder chamber 45 between the tank-side port 1002 connected to the compressed air supply source and the exhaust port 1001. The slide valve 1 further includes the first solenoid 1004 configured to switch the switchable flow path 1006 according to the valve body release command of the controller 1200 such that the cylinder chamber 45 and the tank-side port 1002 are connected together, and the second solenoid 1005 configured to switch the switching flow path 1006 according to the valve body fixing command of the controller 1200 such that the cylinder chamber 45 and the exhaust port 1001 are connected together.

With such a configuration of the slide valve 1, the solenoid valve 1000 does not operate even when the power supply to the solenoid valve 1000 is stopped, and therefore, the state of supplying the compressed air to the slide valve 1 is maintained. Thus, the sealing body 7 can be held at a certain position. For example, even when the power supply to the solenoid valve 1000 is, for replacement of a component such as the seal material 723 or the seal ring 720 of the sealing body 7, stopped during the compressed air supply to the slide valve 1, no problem is caused. That is, even when the power supply to the solenoid valve 1000 is stopped, the position of the sealing body 7 does not change, and therefore, there is no trouble in a component replacement process. For example, this avoids the moving sealing body 7 from catching a finger during the component replacement process.

If a solenoid valve 1000 includes a single solenoid and a spring and is configured to transition to an introduction state for supplying compressed air to a slide valve 1 by voltage application to the solenoid, the following problem is caused. That is, when a power supply is stopped during voltage application to the solenoid, no operation command is output from a controller 1200, but the solenoid valve 1000 transitions to an exhaust state by spring elastic force. Thus, the compressed air is discharged from the slide valve 1, and a sealing body 7 is moved by the elastic force of the compression spring 50. In this state, if a component replacement process etc. are performed, there is a probability that a finger is caught by the moving sealing body 7.

(2) In the slide valve 1 of the present embodiment, when voltage is applied to the first solenoid 1004 and no voltage is applied to the second solenoid 1005, the switching flow path 1006 is switched such that the cylinder chamber 45 and the compressed air supply source are connected together. When voltage is applied to the second solenoid 1005 and no voltage is applied to the first solenoid 1004, the switching flow path 1006 is switched such that the cylinder chamber 45 and the exhaust port 1001 are connected together. When no voltage is applied to the first solenoid 1004 and the second solenoid 1005, the state of the switching flow path 1006 is not changed.

(3) The slide valve 1 further includes, in a line for guiding the compressed air from the compressed air supply source to the switching flow path 1006, the check valve 1100 configured to block the flow from the switching flow path 1006 to the compressed air supply source.

Thus, even in a case where operation of the compressor 1300 is stopped due to any failure or a case where the tank 1400 is damaged, the sealing body 7 can be held at the certain position. This is because the air does not flow back to the tank 1400 by the action of the check valve 1100 even when the pressure of the cylinder chamber 45 reaches higher than that of the tank-side port 1002 in the introduction state in which the tank-side port 1002 and the valve-side port 1003 are connected together. Further, even when the compressed air supply and the power supply to the solenoid valve 1000 are simultaneously stopped, the state of the solenoid valve 1000 does not change as described above. Thus, the sealing body 7 can be held at the certain position.

(4) The slide plate 8 moves in a direction (a right-to-left direction as viewed in FIG. 3) intersecting the direction (the upper-to-lower direction as viewed in FIG. 3) in which the sealing body 7 slidably moves. In other words, the slide plate 8 moves in a direction not parallel to the direction in which the sealing body 7 slidably moves. The sealing body 7 includes the detachable seal materials 711, 712, 721, 722, 723.

The sealing body 7 slidably moves in the direction in which the openings 31, 41 face each other, thereby controlling pressing of the slide plate 8 and releasing of the pressed slide plate 8. The slide plate 8 pressed by the sealing body 7 is released so that the slide plate 8 can move. This changes an area where the slide plate 8 covers the openings 31, 41. Thereafter, the slide plate 8 is pressed by the sealing body 7 such that the position of the slide plate 8 is fixed. The flow rate of gas passing through the slide valve 1 can be adjusted. Since the seal materials 711, 712, 721, 722, 723 are detachable, replacement thereof is facilitated.

Further, even when the power supply to the solenoid valve 1000 is stopped in a situation where the slide plate 8 is not in the fully-closed state, the sealing body 7 can be held at the certain position. Thus, the following problem is not caused. That is, there is no problem that damage of the seal material or dropping of the seal material from the recessed portion is caused when the sealing body 7 contacts the slide plate 8 in a situation where the slide plate 8 is not in the fully-closed state (θ=0).

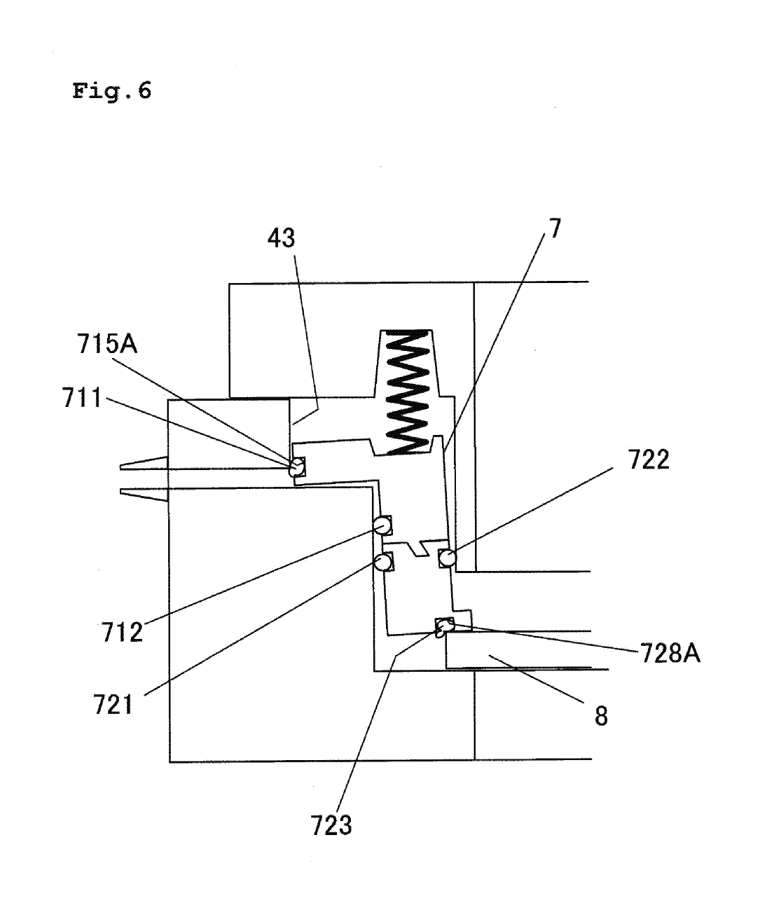

If the sealing body 7 is biased by the compression spring 50 to slidably move toward the fastening surface 6 side in the state in which the slide plate 8 is not in the fully-closed state (θ=0), a state as in FIG. 6 might be brought. FIG. 6 is a view of an example of a situation where the sealing body 7 contacts the slide plate 8 with the slide plate 8 being not fully closed. In FIG. 6, the seal material 723 contacts an end portion of the slide plate 8, and therefore, is deformed. The seal material 711 contacts an end portion of the inner peripheral surface 43 of the housing base portion 4, and therefore, is deformed. In this case, there is a probability that the seal materials 711, 723 are deformed/damaged and that the detachable seal materials 711, 723 are dropped from the recessed portions 715A, 728A. When the seal material is deformed/damaged, sealing becomes insufficient. For this reason, fluid passing through the slide valve 1 cannot be blocked. Moreover, when the seal material is dropped, not only the fluid cannot be blocked, but also the slide valve 1 might be damaged by subsequent operation.

Note that in the example illustrated in FIG. 6, there are problems on the seal material 711 and the seal material 723, but similar problems might be caused on other seal materials, i.e., the seal materials 712, 721, 722.

The above-described embodiment may be modified as follows.

(1) The solenoid valve 1000 is a so-called two-position solenoid valve configured to be switchable between the introduction state and the exhaust state. However, as long as switching between the introduction state and the exhaust state is not made due to stop of the power supply, the solenoid valve may be switchable among three or more states.

The embodiment and the variation have been described above, but the present invention is not limited to these contents. Other aspects conceivable within the scope of the technical idea of the present invention are also included within the scope of the present invention.

What is claimed is:

1. A slide valve comprising:
a housing provided with a pair of openings facing each other;
a valve body detachably inserted between the pair of openings;
an annular sealing body configured to slidably move, in the housing, in a direction in which the pair of openings face each other, thereby contacting the valve body inserted between the pair of openings to bring a valve closed state;
a biasing portion configured to bias the sealing body to the valve closed state;
a cylinder into which compressed air for biasing the sealing body to a valve open state is introduced;
a switching flow path connected to the cylinder and configured to switch a connection destination of the cylinder between a compressed air supply source and an exhaust port;
a first solenoid configured to switch the switching flow path according to a valve body release command such that the cylinder and the compressed air supply source are connected together; and
a second solenoid configured to switch the switching flow path according to a valve body fixing command such that the cylinder and the exhaust port are connected together.

2. The slide valve according to claim 1, wherein
when voltage is applied to the first solenoid and no voltage is applied to the second solenoid, the switching flow path is switched such that the cylinder and the compressed air supply source are connected together,
when voltage is applied to the second solenoid and no voltage is applied to the first solenoid, the switching flow path is switched such that the cylinder and the exhaust port are connected together, and
when no voltage is applied to the first solenoid and the second solenoid, a state of the switching flow path is not changed.

3. The slide valve according to claim 1, further comprising:
in a line for guiding the compressed air from the compressed air supply source to the switching flow path, a check valve configured to block a flow from the switching flow path to the compressed air supply source.

4. The slide valve according to claim 1, wherein
the valve body moves in a direction intersecting a direction in which the sealing body slidably moves, and
the sealing body includes a detachable sealing member.
